(19) United States
(12) Patent Application Publication
(10) Pub. No.: US 2025/0252874 A1
(43) Pub. Date: Aug. 7, 2025

(54) UNIBODY SAFETY INDICATOR FOR OUTSIZED PAYLOADS

(71) Applicant: DYLAN J. AMAR, ORILLIA (CA)

(72) Inventor: DYLAN J. AMAR, ORILLIA (CA)

(21) Appl. No.: 18/432,811

(22) Filed: Feb. 5, 2024

(51) Int. Cl. G09F 17/00; G09F 13/22

(52) U.S. Cl. CPC G09F 17/00; G09F 13/22; G09F 2017/0033; G09F 2017/0083

(57) ABSTRACT

Apparatus and method for a unibody safety indicator for outsized payloads. The safety indicator for outsized payloads comprises a unibody structure having an elastically deformable frame arranged in a closed loop, and a planar flag body integrally and contemporaneously formed with at least a perimeter portion of the closed loop, the planar flag body extending away from the at least a perimeter portion and terminating in a distal end.

### TECHNICAL FIELD

The disclosure herein relates to safety indicator devices including fabrication and deployment thereof.

### BACKGROUND

Outsized or oversized payloads can present unexpected and unacceptable hazards that can be made safer, or at least mitigated, using appropriate safety signs. Specific examples include, but are not limited to, outsized loads on construction sites, outsized loads being transported via transportation vehicles, and in temporary roadway or highway transportation obstructions. For a safety sign to be effectively serve its purpose, it must be readily visible to the public or the persons being warned, even in poor visibility and difficult visibility conditions, including in foggy, dusty, or snowy conditions, at night, and at sufficient range that enables increased likelihood of successfully evading a hazard.

### BRIEF DESCRIPTION OF THE DRAWINGS

FIG. 1 illustrates, in an example embodiment, a unibody safety indicator device for outsized payloads.

FIG. 2 illustrates, in another example embodiment, a unibody safety indicator device for outsized payloads.

FIG. 3 illustrates, in yet another example embodiment, a unibody safety indicator device for outsized payloads.

FIG. 4 illustrates, in another example embodiment, a unibody safety indicator device for outsized payloads.

FIG. 5 illustrates, in yet another example embodiment, a unibody safety indicator device for outsized payloads.

FIG. 6 illustrates, in another example embodiment, a method of fabricating a unibody safety indicator device for outsized payloads.

FIG. 7 illustrates, in an example embodiment, a method of deploying a unibody safety indicator for outsized payloads.

### DETAILED DESCRIPTION

Embodiments herein recognize a need for advantageously providing safety warning indicators that enable increased likelihood of successful evasion of imminent hazards.

Provided is a safety indicator for outsized payloads. The safety indicator comprises a unibody structure having an elastically deformable frame arranged in a closed loop, and a planar flag body integrally and contemporaneously formed with at least a perimeter portion of the closed loop. The planar flag body extends away from the perimeter portion and terminates in a distal end.

Also provided is a method of fabricating a safety indicator item for outsized payloads. The method comprises forming, by way of one of an injection molding fabrication process and a stamping fabrication pocess, a unibody structure having an elastically deformable frame arranged in a closed loop, and a planar flag body integrally and contemporaneously formed in conjunction with at least a perimeter portion of the closed loop, the planar flag body extending away from the at least a perimeter portion and terminating in a distal end.

Further provided is a method of deploying a safety indicator for outsized payloads. The method comprises expanding an elastically deformable frame of a safety indicator arranged in a unibody structure to a size corresponding to a pre-identified perimeter of an outsized payload. The unibody structure includes a planar flag body integrally and contemporaneously formed in conjunction with the elastically deformable frame, the planar flag body extending away from the elastically deformable frame and terminating in a distal end. The method further includes affixing the expanded elastically deformable frame onto the pre-identified perimeter of the outsized payload.

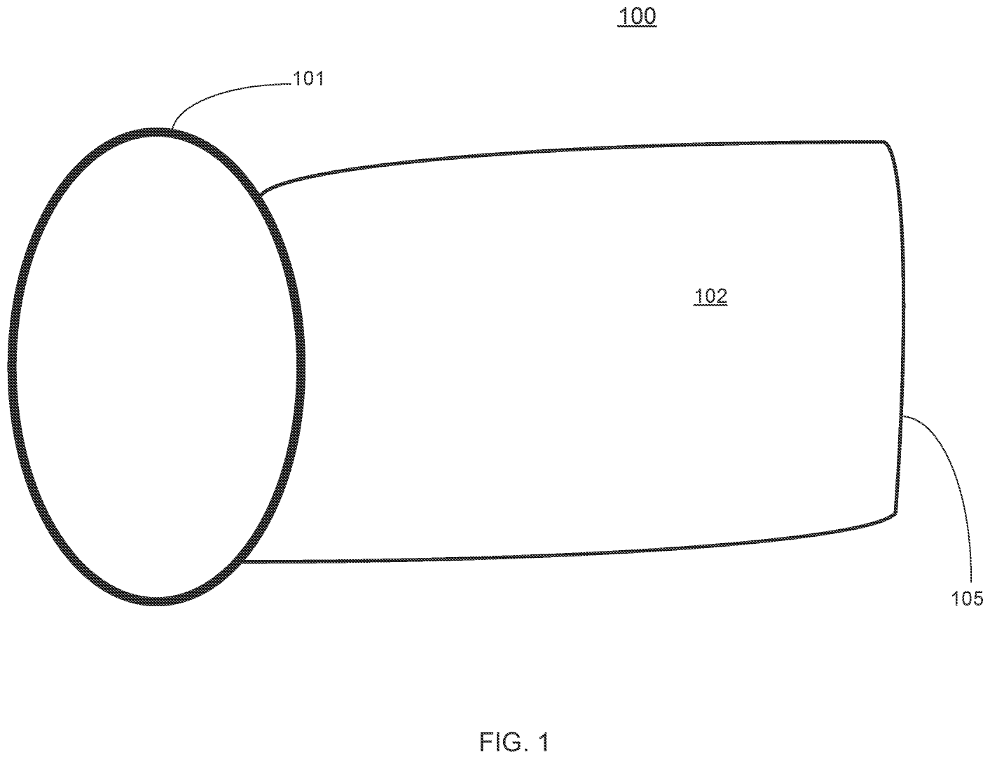

FIG. 1 illustrates, in an example embodiment, a unibody safety indicator device (also referred to herein as “safety indicator”) for outsized payloads. The safety indicator comprises a unibody structure 100 having elastically deformable frame 101 arranged in a closed loop, and planar flag body 102 that is integrally and contemporaneously formed with at least a partial perimeter portion of elastically deformable frame 101. Planar flag body 102 extends away from a perimeter of elastically deformable frame 101 and terminates in a distal end 105.

In embodiments, planar flag body 102 is integrally and contemporaneously formed in conjunction with the perimeter portion of the closed loop by way of an injection molding fabrication process. As used herein, the term “integrally and contemporaneously formed” means that planar flag body 102 and elastically deformable frame 101 are formed, or produced, as a single unit and at the same time during a single manufacturing or fabrication step in accordance with an injection molding process. In this manner, unibody structure 100 avoids or minimizes discontinuities in mechanical, chemical and materials properties that may be inherent to manufactured product consisting of sub-assembled components that are separately produced, and thus provides advantages in mechanical, chemical and materials integrity that are inherent to unibody structure 100. As used herein, the term “unibody” refers to a structure that includes planar flag body 102 and elastically deformable frame 101 that are formed as a single unit using a single manufacturing or fabrication step, which in some embodiments may be produced using an injection molding process step.

In other embodiments, planar flag body 102 may be integrally and contemporaneously formed in conjunction with the perimeter portion of the closed loop by way of a stamping fabrication process performed upon a sheet stock of a rubber compound which may include such as, but not limited to, nitrile material sheet stock and latex rubber sheet stock.

In some embodiments, the elastically deformable frame 100 may be of a round, an oval, or a rectangular cross-section, and having a cross-sectional thickness typically 5 times or greater than a thickness of the planar flag body 102. The thickness of planar flag body 102, in some embodiments, may range from 0.002 inch to 0.010 inch, generally uniform in thickness across the length and width of planar flag body 102.

Unibody structure 100 may be formed of a uniform material constituent. In some embodiments, the uniform material constituent may be a nitrile material that includes at least one of acrylonitrile and butadiene copolymers. In alternative or additional embodiments, the uniform material constituent may be a latex rubber material. The nitrile material may be nitrile butadiene rubber, a copolymer that's formed by the process of bonding the two molecules, butadiene and acrylonitrile. The latex rubber material may be comprised of a natural combination of various proteins and lipids, with chemical compounds added to the sap. Such chemical compounds may include ammonia, sulfur, pigments, zinc oxide, antioxidants, and thiurams that accelerate the latex rubber hardening process.

For enhanced visibility during normal and in difficult visibility conditions, at least a portion of the planar flag body 200 may be of a high visibility color. In other or additional high visibility embodiments, at least a surface portion of the planar fag body 200 may be surface-coated with a high visibility color, or with an electroluminescent coating. In some embodiments, planar flag body 200 may be sized in accordance with a length, a width, or a surface area that is mandated in accordance with one or more legislative safety mandates pertaining to outsized payloads including, but not limited to, transportation of outsized payloads.

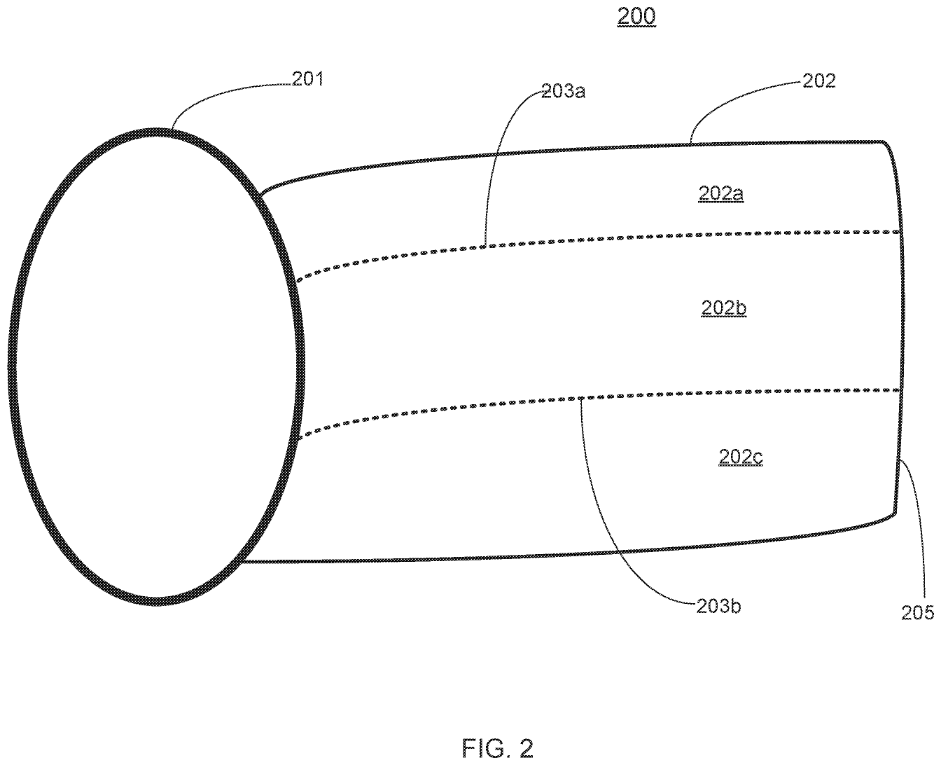

FIG. 2 illustrates, in another example embodiment, unibody safety indicator device 200 for outsized payloads. The safety indicator comprises a unibody structure 200 having elastically deformable frame 201 arranged in a closed loop, and planar flag body 202 that is integrally and contemporaneously formed with at least a partial perimeter portion of elastically deformable frame 201. Planar flag body 202 extends away from a perimeter of elastically deformable frame 201 and terminates in distal end 205.

In embodiments, planar flag body 202 is integrally and contemporaneously formed in conjunction with the perimeter portion of the closed loop by way of an injection molding fabrication process. As used herein, the term “integrally and contemporaneously formed” means that planar flag body 202 and elastically deformable frame 201 are formed, or produced, as a single unit and at the same time during a single manufacturing or fabrication step in accordance with an injection molding process. In this manner, unibody structure 200 avoids or minimizes discontinuities in mechanical, chemical and materials properties that may be inherent to manufactured product consisting of sub-assembled components that are separately produced, and thus provides advantages in mechanical, chemical and materials integrity that are inherent to unibody structure 200. embodiments may be produced using an injection molding process step.

In other embodiments, planar flag body 202 may be integrally and contemporaneously formed in conjunction with the perimeter portion of the closed loop by way of a stamping fabrication process performed upon a sheet stock of a rubber compound which may include such as, but not limited to, nitrile material sheet stock and latex rubber sheet stock.

In embodiments, the elastically deformable frame 200 may be of a round, an oval, or a rectangular cross-section, and having a cross-sectional thickness typically greater than a thickness of the planar flag body 202. The thickness of planar flag body 202, in some embodiments, may range from 0.002 inch to 0.010 inch, generally uniform in thickness across the length and width of planar flag body 202.

Unibody structure 200 may be formed of a uniform material constituent. In some embodiments, the uniform material constituent may be a nitrile material that includes at least one of acrylonitrile and butadiene copolymers. In alternative or additional embodiments, the uniform material constituent may be a latex rubber material. The nitrile material may be nitrile butadiene rubber, a copolymer that's formed by the process of bonding the two molecules, butadiene and acrylonitrile. The latex rubber material may be comprised of a natural combination of various proteins and lipids, with chemical compounds added to the sap. Such chemical compounds may include ammonia, sulfur, pigments, zinc oxide, antioxidants, and thiurams that accelerate the latex rubber hardening process.

In embodiments, flag body 200 may include a plurality of severable segments 202a, 202b, 202c, though it is contemplated that more than 3 segments can be implemented across flag body 200. Each severable segment 202a, 202b, 202c may be defined in accordance with a respective line of perforations 203a, 203b that extends from elastically deformable frame 201 to the distal end 205. In embodiments, the lines of perforations may be generated using specialized injection molding hard tooling during the single step injection molding process, or during the stamping fabrication process, again using hard tooling to create the perforations during the stamping process.

For enhanced visibility during normal and in difficult visibility conditions, one or more of segments 202a-202c of planar flag body 200 may be of a high visibility color. In other or additional high visibility embodiments, one or more of segments 202a-202c of the planar flag body 200 may be surface-coated with a high visibility color, or with an electroluminescent coating. In some embodiments, planar flag body 200 may be sized in accordance with a length, a width, or a surface area that is mandated in accordance with one or more legislative safety mandates pertaining to outsized payloads including, but not limited to, transportation of outsized payloads.

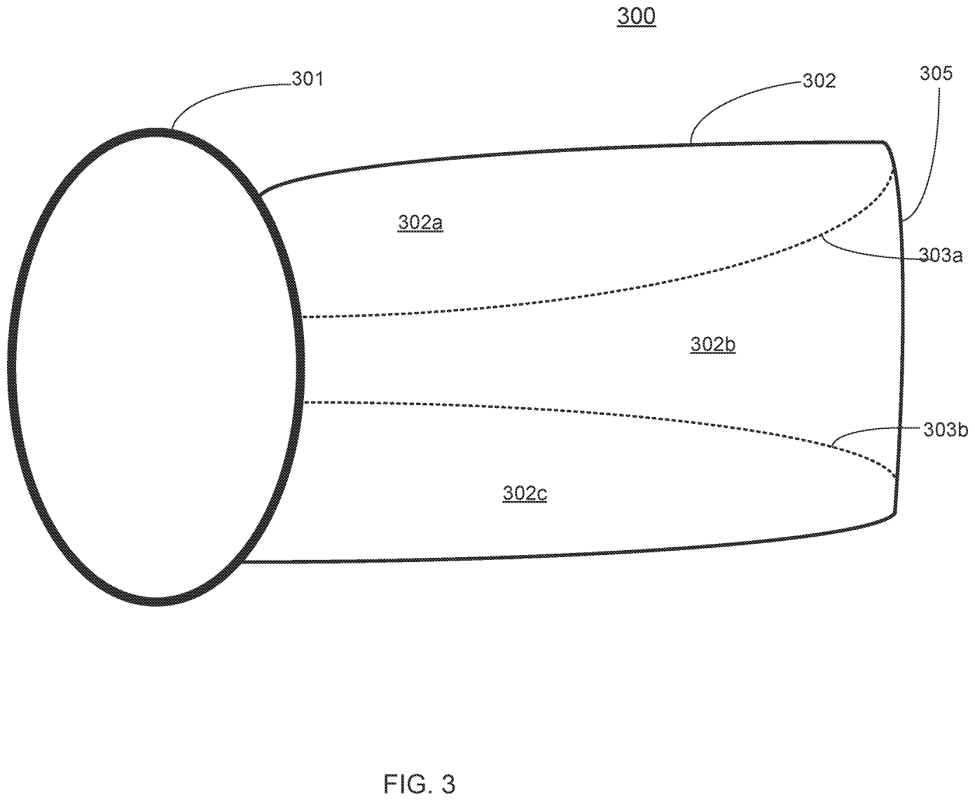

FIG. 3 illustrates, in another example embodiment, unibody safety indicator device 300 for outsized payloads. The safety indicator 300 may comprise a unibody structure 300 having elastically deformable frame 301 arranged in a closed loop, and planar flag body 302 that is integrally and contemporaneously formed with at least a partial perimeter portion of elastically deformable frame 301. Planar flag body 302 extends away from a perimeter of elastically deformable frame 301 and terminates in distal end 305.

In embodiments, planar flag body 302 is integrally and contemporaneously formed in conjunction with the perimeter portion of the closed loop by way of an injection molding fabrication process. As used herein, the term “integrally and contemporaneously formed” means that planar flag body 302 and elastically deformable frame 301 are formed, or produced, as a single unit and at the same time during a single manufacturing or fabrication step in accordance with an injection molding process. In this manner, unibody structure 300 avoids or minimizes discontinuities in mechanical, chemical and materials properties that may be inherent to manufactured product consisting of sub-assembled components that are separately produced, and thus provides advantages in mechanical, chemical and materials integrity that are inherent to unibody structure 300.

In other embodiments, planar flag body 302 may be integrally and contemporaneously formed in conjunction with the perimeter portion of the closed loop by way of a stamping fabrication process performed upon a sheet stock of a rubber compound which may include such as, but not limited to, nitrile material sheet stock and latex rubber sheet stock.

In embodiments, the elastically deformable frame 300 may be of a round, an oval, or a rectangular cross-section, and having a cross-sectional thickness typically greater than a thickness of the planar flag body 302. The thickness of planar flag body 302, in some embodiments, may range from 0.002 inch to 0.010 inch, generally uniform in thickness across the length and width of planar flag body 302.

Unibody structure 300 may be formed of a uniform material constituent. In some embodiments, the uniform material constituent may be a nitrile material that includes at least one of acrylonitrile and butadiene copolymers. In alternative or additional embodiments, the uniform material constituent may be a latex rubber material.

In embodiments, flag body 300 may include a plurality of severable segments 302a, 302b, 302c, though it is contemplated that more than 3 segments can be implemented across flag body 300. Each severable segment 302a, 302b, 302c may be defined in accordance with a respective line of perforations 303a, 303b that extends from elastically deformable frame 301 to the distal end 305. In embodiments, the lines of perforations may be generated using specialized injection molding hard tooling during the single step injection molding process, or during the stamping fabrication process, again using hard tooling to create the perforations during the stamping process.

For enhanced visibility during normal and in difficult visibility conditions, one or more of segments 302a-302c of planar flag body 300 may be of a high visibility color. In other or additional high visibility embodiments, one or more of segments 302a-302c of the planar flag body 300 may be surface-coated with a high visibility color, or with an electroluminescent coating. In some embodiments, planar flag body 300 may be sized in accordance with a length, a width, or a surface area that is mandated in accordance with one or more legislative safety mandates pertaining to outsized payloads including, but not limited to, transportation of outsized payloads.

In embodiments, each respective line of perforations 303a, 303b respectively corresponding to the segments 302a-302c may form a geometrically divergent pattern from the frame 301 to the distal end 305 and render each of the segments 302a-302c capable of at least partial severability from the other segments of flag body 302. In embodiments, the lines of perforations may be generated using specialized injection molding hard tooling during the single step injection molding process, or during the stamping fabrication process, again using hard tooling to create the perforations during the stamping process.

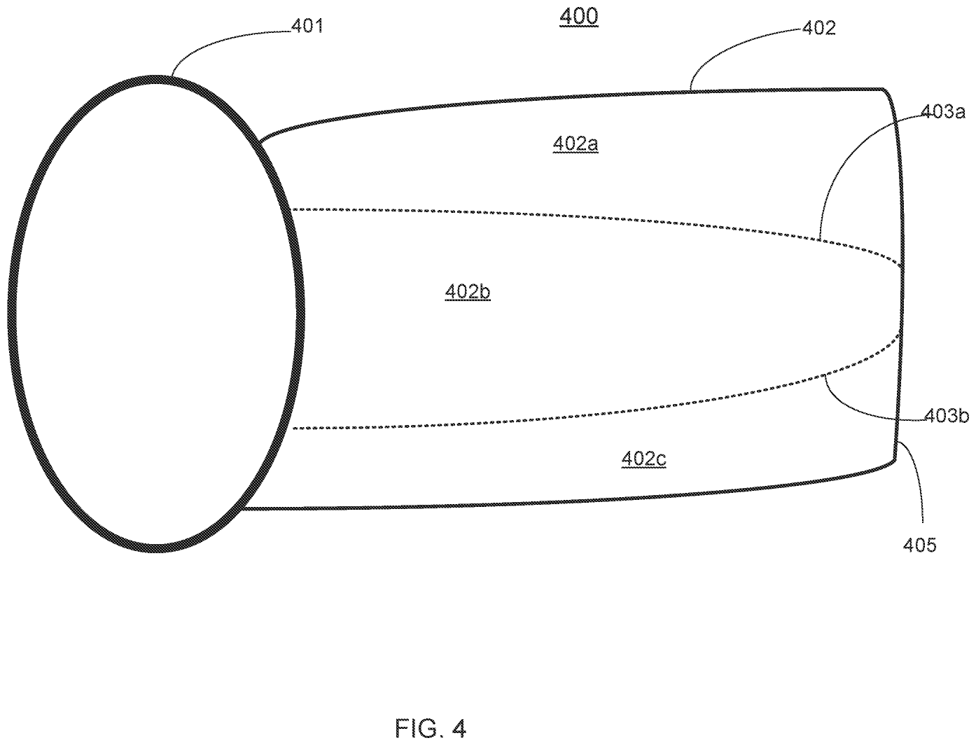

FIG. 4 illustrates, in another example embodiment, unibody safety indicator device 400 for outsized payloads. unibody safety indicator device 300 for outsized payloads. The safety indicator 400 may comprise a unibody structure 400 having elastically deformable frame 401 arranged in a closed loop, and planar flag body 402 that is integrally and contemporaneously formed with at least a partial perimeter portion of elastically deformable frame 401. Planar flag body 402 extends away from a perimeter of elastically deformable frame 401 and terminates in distal end 405.

In embodiments, planar flag body 402 is integrally and contemporaneously formed in conjunction with the perimeter portion of the closed loop by way of an injection molding fabrication process. As used herein, the term “integrally and contemporaneously formed” means that planar flag body 402 and elastically deformable frame 401 are formed, or produced, as a single unit and at the same time during a single manufacturing or fabrication step in accordance with an injection molding process. In this manner, unibody structure 400 avoids or minimizes discontinuities in mechanical, chemical and materials properties that may be inherent to manufactured product consisting of sub-assembled components that are separately produced, and thus provides advantages in mechanical, chemical and materials integrity that are inherent to unibody structure 400.

In other embodiments, planar flag body 402 may be integrally and contemporaneously formed in conjunction with the perimeter portion of the closed loop by way of a stamping fabrication process performed upon a sheet stock of a rubber compound which may include such as, but not limited to, nitrile material sheet stock and latex rubber sheet stock.

In embodiments, the elastically deformable frame 400 may be of a round, an oval, or a rectangular cross-section, and having a cross-sectional thickness typically greater than a thickness of the planar flag body 402. The thickness of planar flag body 402, in some embodiments, may range from 0.002 inch to 0.010 inch, generally uniform in thickness across the length and width of planar flag body 402.

Unibody structure 400 may be formed of a uniform material constituent. In some embodiments, the uniform material constituent may be a nitrile material that includes at least one of acrylonitrile and butadiene copolymers. In alternative or additional embodiments, the uniform material constituent may be a latex rubber material.

In embodiments, flag body 400 may include a plurality of severable segments 402a, 402b, 402c, though it is contemplated that more than 3 segments can be implemented across flag body 400. Each severable segment 402a, 402b, 402c may be defined in accordance with a respective line of perforations 403a, 403b that extends from elastically deformable frame 401 to the distal end 405. In embodiments, the lines of perforations may be generated using specialized injection molding hard tooling during the single step injection molding process, or during the stamping fabrication process, again using hard tooling to create the perforations during the stamping process.

For enhanced visibility during normal and in difficult visibility conditions, one or more of segments 402a-402c planar flag body 400 may be of a high visibility color. In other or additional high visibility embodiments, one or more of segments 402a-402c of the planar flag body 400 may be surface-coated with a high visibility color, or with an electroluminescent coating. In some embodiments, planar flag body 400 may be sized in accordance with a length, a width, or a surface area that is mandated in accordance with one or more legislative safety mandates pertaining to outsized payloads including, but not limited to, transportation of outsized payloads.

In the embodiment of FIG. 4, each respective line of perforations 403a, 403b corresponding to the of segments 402a-402c may form a geometrically convergent pattern from the frame 402 to distal end 405 and render each of the segments 402a-402c capable of at least partial severability from the other segments.

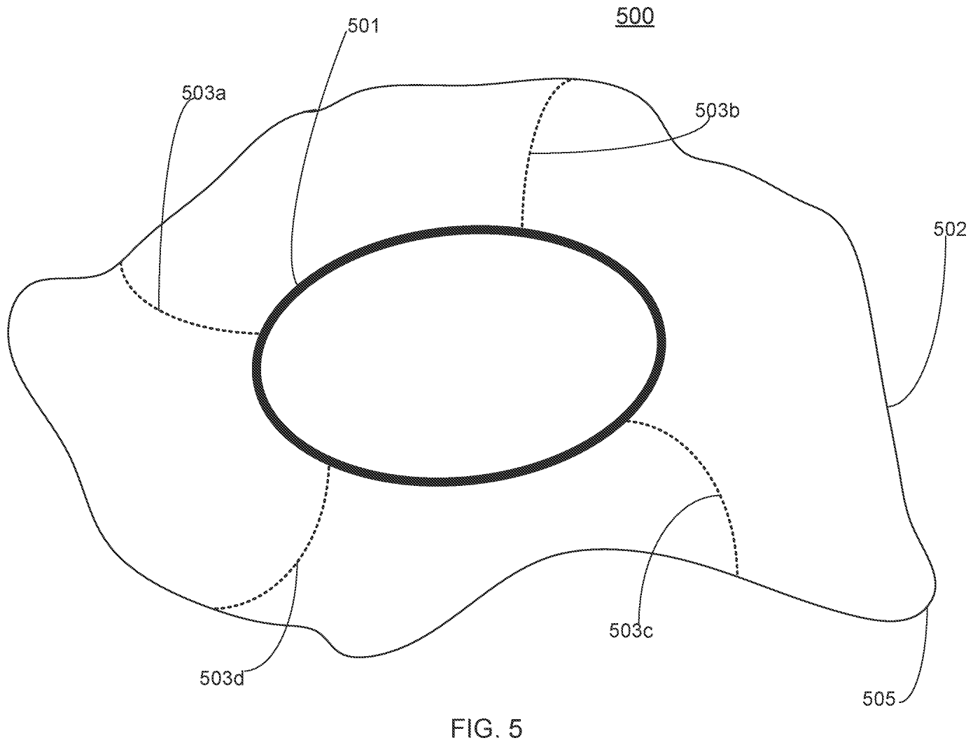

FIG. 5 illustrates, in another example embodiment, in another example embodiment, unibody safety indicator device 500 for outsized payloads. unibody safety indicator device 300 for outsized payloads. The safety indicator 500 may comprise a unibody structure 500 having elastically deformable frame 501 arranged in a closed loop, and planar flag body 502 that is integrally and contemporaneously formed with at least a partial perimeter portion of elastically deformable frame 501. Planar flag body 502 extends away from a perimeter of elastically deformable frame 501 and terminates in distal end 505.

In embodiments, planar flag body 502 is integrally and contemporaneously formed in conjunction with the perimeter portion of the closed loop by way of an injection molding fabrication process. As used herein, the term “integrally and contemporaneously formed” means that planar flag body 502 and elastically deformable frame 501 are formed, or produced, as a single unit and at the same time during a single manufacturing or fabrication step in accordance with an injection molding process. In this manner, unibody structure 500 avoids or minimizes discontinuities in mechanical, chemical and materials properties that may be inherent to manufactured product consisting of sub-assembled components that are separately produced, and thus provides advantages in mechanical, chemical and materials integrity that are inherent to unibody structure 500.

In other embodiments, planar flag body 502 may be integrally and contemporaneously formed in conjunction with the perimeter portion of the closed loop by way of a stamping fabrication process performed upon a sheet stock of a rubber compound which may include such as, but not limited to, nitrile material sheet stock and latex rubber sheet stock.

In embodiments, the elastically deformable frame 500 may be of a round, an oval, or a rectangular cross-section, and having a cross-sectional thickness typically greater than a thickness of the planar flag body 502. The thickness of planar flag body 502, in some embodiments, may range from 0.002 inch to 0.010 inch, generally uniform in thickness across the length and width of planar flag body 502.

Unibody structure 500 may be formed of a uniform material constituent. In some embodiments, the uniform material constituent may be a nitrile material that includes at least one of acrylonitrile and butadiene copolymers. In alternative or additional embodiments, the uniform material constituent may be a latex rubber material.

In embodiments, flag body 500 may include a plurality of severable segments 502a, 502b, 502c, though it is contemplated that more than 3 segments can be implemented across flag body 500. Each severable segment 502a, 502b, 502c may be defined in accordance with a respective line of perforations 503a, 503b that extends from elastically deformable frame 501 to the distal end 505. In embodiments, the lines of perforations may be generated using specialized injection molding hard tooling during the single step injection molding process, or during the stamping fabrication process, again using hard tooling to create the perforations during the stamping process.

For enhanced visibility during normal and in difficult visibility conditions, one or more of segments 502a-502c planar flag body 500 may be of a high visibility color. In other or additional high visibility embodiments, one or more of segments 502a-502c of the planar flag body 500 may be surface-coated with a high visibility color, or with an electroluminescent coating. In some embodiments, planar flag body 500 may be sized in accordance with a length, a width, or a surface area that is mandated in accordance with one or more legislative safety mandates pertaining to outsized payloads including, but not limited to, transportation of outsized payloads.

In the embodiment of FIG. 5, each respective line of perforations 503a-503d defining segments of flag body 502 may render each of the segments capable of at least partial severability from the other segments.

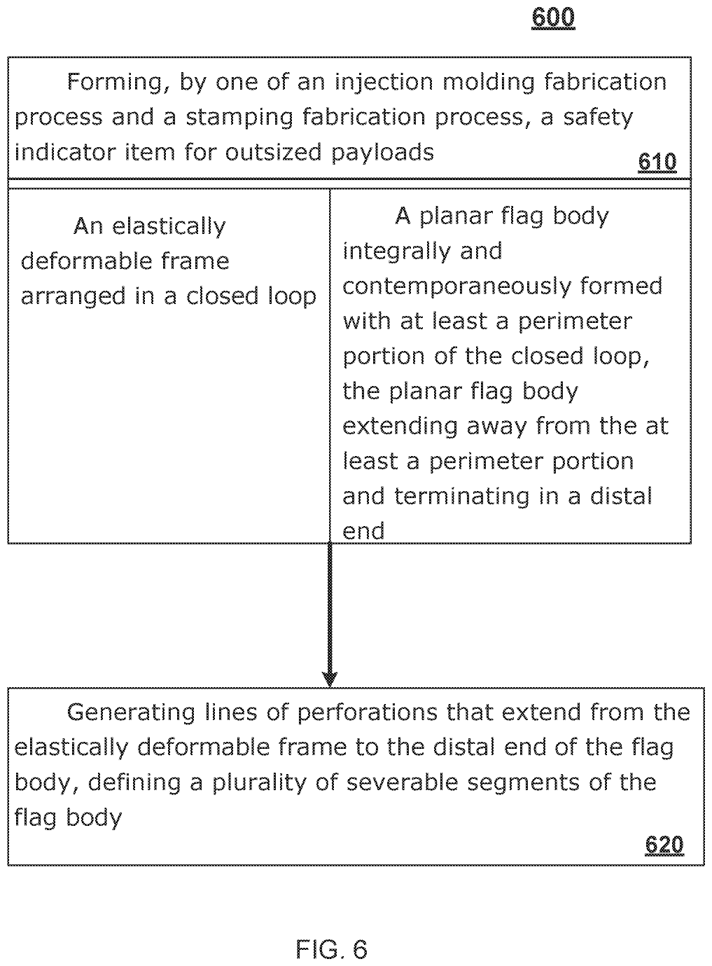

FIG. 6 illustrates, in an example embodiment, method 600 of fabricating unibody safety indicator 100-500 for outsized payloads. Method 600 may be performed with regard to any embodiments described herein, including as described in conjunction with FIGS. 1-5.

At block 610, forming, by way of one of an injection molding fabrication process and a stamping fabrication process, a unibody structure having an elastically deformable frame 101-501 arranged in a closed loop, and planar flag body 102-502 being integrally and contemporaneously formed with at least a perimeter portion of the closed loop, the planar flag body 102-502 extending away from the at least a perimeter portion of frame 101-502 and terminating in a distal end 105-505.

At block 620, generating lines of perforations that extend from the elastically deformable frame to the distal end of the flag body, defining a plurality of severable segments of the flag body 102-502. In embodiments, the lines of perforations may be generated using specialized injection molding hard tooling during the single step injection molding process, or during the stamping fabrication process, again using appropriate hard tooling to create the perforations during a single-step stamping fabrication process.

In some aspects, the unibody structure 100-500 may be constituted of a uniform material substance. The uniform material constituent, in some embodiments, may be a nitrile material that includes at least one of acrylonitrile and butadiene copolymers. In some embodiments, the uniform material constituent may be a latex rubber.

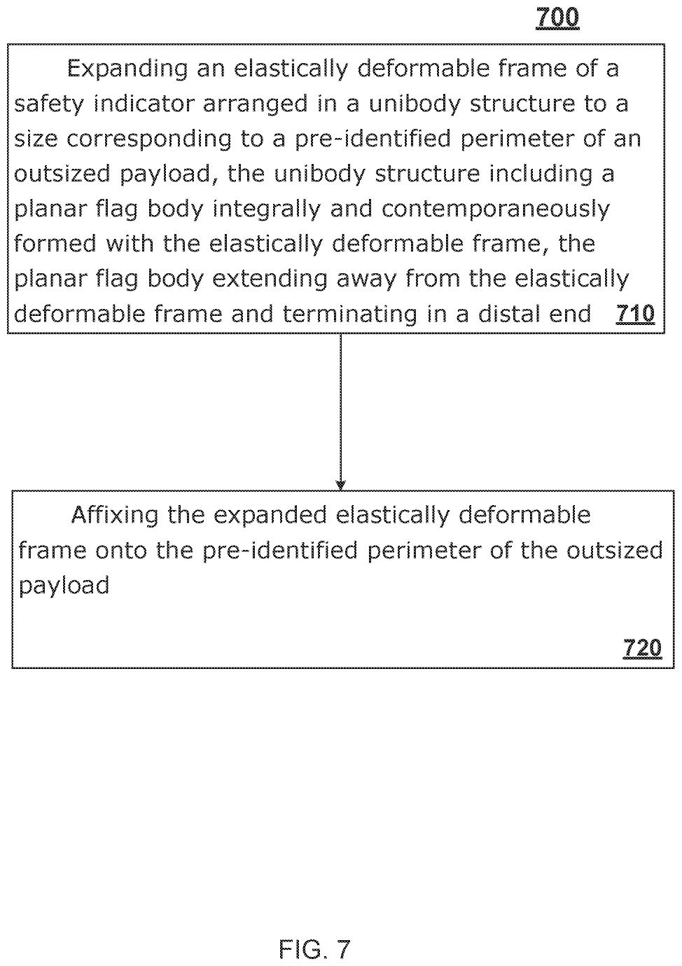

FIG. 7 illustrates, in an example embodiment, method 700 of deploying a unibody safety indicator for outsized payloads.

At step 710, expanding an elastically deformable frame 101-501 of a safety indicator arranged in unibody structure 100-500 to a size corresponding to a pre-identified perimeter of an outsized payload, the unibody structure 100-500 including a planar flag body 102-502 integrally and contemporaneously formed with elastically deformable frame 101-501, the planar flag body 102-502 extending away from the elastically deformable frame 101-501 and terminating in distal end 105-505.

At step 720, affixing expanded elastically deformable frame 101-510 onto the pre-identified perimeter of the outsized payload.

In some embodiments, at least one of the steps of expanding the elastically deformable frame of the safety indicator and affixing the expanded elastically deformable frame onto the pre-identified perimeter of the outsized payload may be performed manually.

Although embodiments are described in detail herein with reference to the accompanying drawings, it is intended that disclosures herein not be limited to literal depictions of the embodiments illustrated by way of examples. As such, many modifications and equivalents of the unibody safety indicator devices for outsized payloads, and variations in sequence of the method steps in deployment thereof, will be apparent to practitioners skilled in the art. Accordingly, it is intended that the invention encompasses scope in accordance with the following claims and their equivalents. Furthermore, it is contemplated that a particular feature described either individually or as part of an embodiment can be combined with other individually described features, or portions of other embodiments described herein. Thus, absence of described particular combinations does not preclude the inventor from claiming rights to such combinations.

What is claimed is:

1. A safety indicator for outsized payloads, the safety indicator comprising:
a unibody structure having:
an elastically deformable frame arranged in a closed loop; and
a planar flag body integrally and contemporaneously formed with at least a perimeter portion of the closed loop, the planar flag body extending away from the at least a perimeter portion and terminating in a distal end.

2. The safety indicator of claim 1 wherein the planar flag body is integrally and contemporaneously formed in conjunction with the at least a perimeter portion of the closed loop by way of one of an injection molding fabrication process and a stamping fabrication process.

3. The safety indicator of claim 2 wherein the elastically deformable frame comprises one of a cross-sectional diameter and a cross-sectional thickness greater than a thickness of the planar flag body.

4. The safety indicator of claim 2 wherein the unibody structure comprises one of an injection molded structure formed by way of the injection molding fabrication process and a stamped structure formed by way of the stamping fabrication process.

5. The safety indicator of claim 4 wherein the unibody structure comprises a uniform material constituent.

6. The safety indicator of claim 5 wherein the uniform material constituent comprises a nitrile material that includes at least one of acrylonitrile and butadiene copolymers.

7. The safety indicator of claim 5 wherein the uniform material constituent comprises a latex rubber.

8. The safety indicator of claim 1 wherein the planar flag body comprises a plurality of severable segments, each severable segment of the plurality defined in accordance with a respective line of perforations that extends from the elastically deformable frame to the distal end.

9. The safety indicator of claim 8 wherein each respective line of perforations corresponding to the plurality of segments form a geometrically convergent pattern from the frame to the distal end and render each of the plurality of segments capable of at least partial severability from others of the plurality.

10. The safety indicator of claim 8 wherein each respective line of perforations corresponding to the plurality of segments form a geometrically divergent pattern from the frame to the distal end and render each of the plurality of segments capable of at least partial severability from others of the plurality.

11. The safety indicator of claim 1 wherein at least a portion of the planar flag body comprises a high visibility color.

12. The safety indicator of claim 1 wherein at least a surface portion of the planar fag body comprises an electroluminescent coating.

13. The safety indicator of claim 1 wherein the planar flag body comprises at least one of a length, a width, a surface area and a size that is mandated in accordance with a legislative safety mandate pertaining to transportation of outsized payloads.

14. A method of producing a safety indicator item for outsized payloads, the method comprising:
forming a unibody structure having:
an elastically deformable frame arranged in a closed loop; and
a planar flag body integrally and contemporaneously formed with at least a perimeter portion of the closed loop, the planar flag body extending away from the at least a perimeter portion and terminating in a distal end.

15. The method of claim 14 wherein forming the unibody structure comprises one of an injection molding fabrication process and a stamping fabrication process.

16. The method of claim 14 wherein the unibody structure comprises a uniform material constituent of a nitrile material that includes at least one of acrylonitrile and butadiene copolymers.

17. The method of claim 14 wherein the unibody structure comprises a uniform material constituent of a latex rubber material.

18. A method of deploying a safety indicator for outsized payloads, the method comprising:
expanding an elastically deformable frame of a safety indicator arranged in a unibody structure to a size corresponding to a pre-identified perimeter of an outsized payload, the unibody structure including a planar flag body integrally and contemporaneously formed with the elastically deformable frame, the planar flag body extending away from the elastically deformable frame and terminating in a distal end; and
affixing the expanded elastically deformable frame onto the pre-identified perimeter of the outsized payload.

19. The method of claim 18 wherein expanding the elastically deformable frame comprises manually expanding the elastically deformable frame.

20. The method of claim 18 wherein affixing the expanded elastically deformable frame onto the pre-identified perimeter of the outsized payload comprises manually affixing the elastically deformable frame.
